(19) United States
(12) Patent Application Publication
(10) Pub. No.: US 2022/0383372 A1
(43) Pub. Date: Dec. 1, 2022

(54) METHODS FOR MANAGING ELECTRONIC TRANSACTIONS AND DEVICES THEREOF

(71) Applicant: Trellist, Inc., Wilmington, DE (US)

(72) Inventors: David Erdem Atadan, Chadds Ford, PA (US); Thomas Adil Atadan, Mooresville, NC (US)

(21) Appl. No.: 17/824,497

(22) Filed: May 25, 2022

Related U.S. Application Data
(60) Provisional application No. 63/192,844, filed on May 25, 2021.

(51) Int. Cl. G06Q 30/06

(52) U.S. Cl. CPC G06Q 30/0609; G06Q 30/0617; G06Q 30/0635

(57) ABSTRACT

A computer-implemented method for managing electronic transactions includes receiving a commodity to be listed for sale. In addition, a purchase request for the commodity listed for sale is received. It is determined when to report a pre-disclosure data and request for a condition report data for the commodity listed for sale. Sale of the commodity based on the determined pre-disclosure data and the condition report data is completed.

This application claims the benefit of U.S. Provisional Patent Application Ser. No. 63/192,844, filed May 25, 2021, which is hereby incorporated by reference in its entirety

### TECHNICAL FIELD

Embodiments of the present invention generally relate to systems and methods for managing electronic transactions and are particularly directed to assisting a buyer to buy and seller to sell a commodity via an escrow account.

### BACKGROUND

Buying vehicle inventory at a digital auction platform where the product is physically sight unseen creates certain dilemmas for consumers who are selling and buying the commodity.

If a potential buyer/bidder was at a digital auction site that had the ability for a third party to validate what the seller has posted about the listing for sale, then that would give them more confidence that the list is actually accurate and they are buying what they thought by the description provided. This is partially exasperated at digital auction because the bidders and seller are not brought together directly, in an effort of the platform company to try and not allow buyers and sellers to go around the process of buying through the auction (to avoid the platform fees). Thus the description and pictures are the basis for buying, creating a dilemma for most to potentially get a deal, that auctions can inherently create for both parties if done for buyers and sellers with confidence.

A simple solution to that problem, currently in the market, is a conditional report created by a third party prior to listing the product whether it be auction or classified. The problem with this is threefold. First, the seller would be obligated to pay the condition report before selling the product which is an expensive proposition that most do not want to do due to the fact that the sale may not go through and this would further put them into debt which they are trying to reduce by selling a listing. Second, the listing by the condition reporter will be limited to the things that they list or report on, versus things that a buyer may want to know. Third is that many items in the condition report are subjective and thus there needs to be a way to consider this from a buyer's perspective. Another problem inherent to digital auction is buyer's remorse, where if they don't pay immediately upon winning an auction, they may not want to purchase any longer. These same issues also apply to a classified listing with a set price for something sight unseen.

In prior techniques, if someone is going to purchase a commodity (e.g., a used vehicle with interpretive value), a seller is often required to pay for a condition report before the buyer will have the confidence to move on a purchase. A condition report done ahead of sale can be expensive, reduce the cost basis of the final sale price and redundant because a condition report is not a guarantee of sale and will often need to be performed multiple times to satisfy various potential buyers. This is detrimental to a seller's potential profit.

The expected outcomes of condition reports are all also defined and scrutinized by buyers which has an adverse effect on final sale price and conversion rate. For example, Buyer A may have different expectations than Buyer B. Buyer A's condition report requirements may be more costly and may result in Buyer A not following through with the sale. Buyer B's condition report may be simpler but this could lead to the commodity not meeting undefined expectations from Buyer B and lead to a failed sale.

Finally, the negative impacts on buyers, sellers and overall sale confidence listed above affect the quality of ad hoc and informal agreements that buyers and sellers often draft to facilitate and set the terms of exchanges. These agreements often leave out the primary reasons that exchanges of interpretive value commodities often fall through: condition not reported accurately, transfer of funds. In an attempt to save money by not condition reporting, sellers draft loose agreements and buyers use that to their advantage when the item purchased sight-unseen does not meet some arbitrary quality standard. As a result, purchasing online or sight-unseen is labeled dangerous for risk averse consumers.

### SUMMARY

The technology discloses a method for facilitating purchase and sale of commodities, applies novel risk management and eliminates unnecessary cost burdens that are often required before utilizing existing industry tools. The order of operations from intent to purchase, going under contract, moving money into an escrow account and having condition reporting performed on the commodity in question has been refactored in the best interest of consumers and is not being done this way anywhere else in the industry.

In the disclosed technology, auction listing is free to list unless sold (but classifieds cost small fee up front) with condition reporting paid for by the seller to the condition reporter themselves after intent to purchase is established. Additionally, the disclosed technology can make recommendations of condition reporters but is not involved in that part of the process.

Further, in the disclosed technology, the condition reporting after the sale is made on whatever the seller had listed that the seller chooses to be reported on within the total listing description. Some items may be listed by the seller but chooses to not have reported on (could be avoiding it due to cost to validate it, etc.), or other items on a typical condition report may not be listed at all by the seller as a way to be truthful on all reported but omitting things they may not wish to disclose; thereby making it incumbent upon a buyer to know be diligent. The sellers' description of items they list which they choose to be reported on is validated as truthful or not by the third party reporter.

Further, in this example, during the auction, bidders/potential buyers can ask about other items to be condition reported on, such as omitted items the seller was trying to get away with, and if the seller agrees, that is then added to the description list. If the seller does not choose to list it as being reportable on, they may lose the buyer.

Additionally, in the disclosed technology, the condition reporter would report based only on what the seller has identified to report on and only reports on it in the way that the seller has listed for it to be reported on, with specifications for whether the condition should be “exact, or seemingly correct (percentage tolerance), or subjective.’ “Exact” could be used for something such as exact mileage. “Seemingly close” could be that the vehicle is still driven and thus the mileage may be within 5% difference of what is listed. Subjective could be for something such as “paint is perfect”.

In the disclosed technology, the condition reporter is an entity that can be looked up for its ethics. The buyer has the choice to not buy as a result of an inadequate condition reporter. This pushes the sellers to not only list accurately, but then to get reputable condition reporters. The potential buyer can request an additional condition reporter as a contingency in order for them to buy.

Furthermore, in the disclosed technology, the seller is provided with a form from the auction listing to be reported on. Additionally, the disclosed technology will provide the seller with a form for the condition reporters, so that the condition reporter understands that the buyer cannot attempt to sue them for their report. This will also be listed in the buyer's terms and conditions. In the event of fraud from the seller, just as all auctions or sales go, the buyer would then have to take the seller to court. In the event the condition reporter is brought to court the condition reporter would most likely report why they reported as they did, while under oath, and if they participated in fraud that is where they can be liable, but not directly.

Furthermore, in the disclosed technology, the bidder/potential buyer may want certain conditional reports to add things that they want to know about. The disclosed technology allows for the buyers, through the agents, to ask the sellers to include those into the listings so that anyone who then bids can see the additional things that are being conditioned reported on. This is at the sellers discretion to add it.

In the disclosed technology, in regards to the seller not wanting the buyer's remorse to occur during the conditional reporting time frame after the sale, in this example, a mandatory escrow fund for the buyer to place a minimum 10% of the fee in with 7 days of the sale, and the money is released to the seller upon the condition reporting being completed, within 10 days of the money being placed in escrow. The money goes into an escrow that disclosed technology can recommend but is not involved in. They are to complete their transaction as they desire from that point forward. The 10% can be kept by the seller in the event the buyer's remorse kicks in.

Furthermore, this condition reporting will also occur the same way with classifieds. The difference is that in classifieds there is typically an opportunity for the seller and buyer to connect ahead of the sale and so “sight unseen” still applies, even though they may feel better if the seller feels right to the buyer. However, that feeling is clearly trumped by the buyer also being able to have the third party condition reporter validate the listing. They buyer will pay a small fee if buys through the platform to get the terms and conditions with the third party reporter.

Additionally, the disclosed technology also helps the digital marketing connector platform that provides the service for sellers and buyers to get together and exchange product by giving them a value where the buyers and sellers would not attempt to go around the platform to save fees.

In an auction scenario the buyer definitely would want to know what they are getting, and would want to get a deal for something with interpretive value, with the disclosed technology. They would not be enticed as much as they may be now to go around the platform by a seller saying “you can save the fees by not going through that platform, and just work with us on that price”. Even though that is not legal or ethical that is a dilemma for platforms like this.

In the case of listing in classified the same applies because the fees are small. And in classifieds, they can actually connect with the potential buyer, where in the auction there's an agent trying to prevent direct contact. With the seller in those classifieds the fee is paid up front as well so they can't go around us. And even though the buyer can still try to save, the buyer's fee in classifieds would only have a $100 fee which they would most likely not go around due to the condition reporting value. The rationale for the classifieds to have a different price is that, in an auction the market is really setting the price, versus in a classified it is the best negotiation between two parties. The communication between parties, mediated by an agent, as well as the associated fees are automatically handled within the embodiment of this method and are part of the process.

In addition, the disclosed technology provides the following advantages: pre-disclosure of condition reported attributes and the identification of condition reporters increases customer confidence by properly accounting for the largest factor in sales falling through: not meeting expectations; pre-disclosure of condition reported attributes and the identification of condition reporters encourages communication between buyer and seller that can further improve buyer confidence by adding additional attributes to be reported on or adding an additional condition reporter as a service provider, increasing the odds of a competed sale; pre-disclosure of said attributes improves price targeting by defining quality standards that have impacts on perceived value; pre-disclosure of said attributes reduces unexpected costs when paying for a condition report because a condition reporter could provide the seller with a quote in advance rather than a different quote every time a new buyer came to the table with their own list of conditions; performing a condition report after a buyer and seller have moved under contract and funds have been deposited in escrow allows rational due diligence to determine if a sale shall be final instead of an emotional reaction that a customer may have when they are surprised by a discrepancy with their expectation; mandatory condition reporting at this point in the sales funnel ensures that all points in a well-constructed agreement are satisfied, which justifies the release of moneys held in escrow to the seller. Similarly, if a condition report returns with inconsistent results, the release of moneys back to the buyer is justified by a well-defined agreement originated at the point of intent to purchase.

Additionally, in this disclosed technology, ownership of a commodity is transferred where the condition of the goods will always meet expectations before sales are final and sales that fail will always result in parties in good standing being made whole, thus reducing risk.

Embodiments provide a computer-implemented method for managing electronic transactions includes receiving a commodity to be listed for sale. In addition, a purchase request for the commodity listed for sale is received. It is determined when to report a pre-disclosure data and request for a condition report data for the commodity listed for sale. Sale of the commodity based on the determined pre-disclosure data and the condition report data is completed.

In another embodiment, a buyer instruction and a seller instruction to an escrow account hosted via an escrow server to complete the sale of the commodity is received.

In yet another embodiment selling condition data associated with the commodity is received.

In another embodiment, the selling condition data to the buyer responsive to the received purchase request is provided. Further, a listing fee and a purchase fee for the commodity is processed. Furthermore, the escrow account when the condition report data is not provided within a determined time period is released.

In another illustrative embodiment, a non-transitory computer readable medium comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a full question generation processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an exemplary network environment 10 including a transaction management system 14 for managing electronic transactions;

FIG. 2 is a block diagram of an exemplary transaction management system 14;

FIGS. 3-5E are exemplary flowcharts illustrating a method for managing electronic transactions; and

FIG. 6 is an exemplary image illustrating a condition report.

### DETAILED DESCRIPTION OF EXEMPLARY EMBODIMENTS

The present invention may be a system, a method, and/or a computer program that consists of a specialized process for buyers and sellers of commodities as well as third party condition reporters and escrow service providers. The specialized process specifically arranges the steps in the transfer of ownership in order to ensure the disclosed condition of a commodity is validated after intent to purchase occurs. Then, money is not transferred until validation is complete and conditions are met. The computer program product may include a computer-readable storage medium (or media) having computer-readable program instructions thereon for causing a processor to carry out aspects of the present invention.

In the first step, the seller uses the disclosed technology to disclose the condition of the commodity using a graphical interface, as well as the condition reporter who will perform the assessment. By using the disclosed technology, particularly with respect to the condition reporting, the buyers have a higher confidence level to bid and the potential buyers can ask for specific items to be condition reported on, such as omitted items the seller did not originally input. If the seller agrees, those additional items are added to the description list for all buyers to see. Additionally, in the disclosed technology, potential buyers can search for the authenticity of the condition-reporter and choose to not buy as a result of an inadequate results. Furthermore, potential buyers do not have to pay to have condition reports done on vehicles they are looking to purchase and only have to pay 3% if their purchase is successful. This constitutes the next step in the process, wherein the buyer has evaluated the commodity's conditions and the listed condition validator via a graphical interface in order to determine if the commodity is desirable for purchase.

With respect to the classifieds example of the disclosed technology, potential buyers can “buy now” on vehicles that have a set, defined value rather than “perceived value”, e.g. an un-modified car and for the escrow partner, the buyer now has the opportunity to ensure they will not get slighted in the event a sale goes through and a condition report does not occur as promised.

With respect to the sellers, the condition reporting in the disclosed technology can amplify their chances of selling—the seller's description of details on their listing is reported on and validated as truthful or not by the third party reporter, which can come in variations to help them: “Exact” could be used for something such as exact mileage; “Seemingly close” could be that the vehicle is still driven and thus the mileage may be within 5% difference of what is listed; and “Subjective” could be for something such as “paint is perfect.” Additionally, potential buyers can search for the authenticity of the condition-reporter meaning, if the seller utilizes reputable reporters, they are have higher chance of selling on the site. Furthermore, the auction listing is still free to list unless sold even with condition reporting and therefore the users can continue to save money.

Additionally, with the disclosed technology, if the seller has a vehicle that is not specialized or modified, they can still list it on the site and move their inventory quickly through this selling option. Furthermore, straight-forward pricing up-front that does not vary by sale price.

The process continues here. In the disclosed technology, a mandatory escrow fund for the buyer to place a minimum of 10% deposit within 7 days of the sale. The monies is released to the seller upon the condition reporting being completed, within 10 days post deposit. The monies goes into an escrow that disclosed technology can recommend but is not involved in. They are to complete their transaction as they desire from that point forward. The 10% can be kept by the seller in the event the buyer's remorse kicks in. Furthermore, in the disclosed technology, a list of conditioning reporters can be included but will not be involved in the process of who the seller chooses. Additionally, the disclosed technology limits fraud by the seller thus ensuring the buyer and the condition reporter will be honest and have no liability in the process. Furthermore, the disclosed technology limits the deals out the system. In other words, with the built-in condition reporting, buyers and sellers are more likely to make their deals using the disclosed technology.

Furthermore, with the disclosed technology more sellers will be likely to add different vehicles and the disclosed technology would be more likely to accept them if they are not being auctioned for a value that the disclosed technology has already pre-set. Additionally, because they pay a fee up-front, the disclosed technology allows sellers and buyers to connect with each other, limiting our overhead costs. Furthermore, with cars that have pre-set values, it is easier to list them at the appropriate price based on the market. In this example, the disclosed technology gives the buyer and seller more incentive to go through our platform for protection and support.

Furthermore, an additional step takes place while the buyer and seller are following the algorithm that determines if the sale is final. After the buyer has placed the deposit and escrow the seller is updated via a graphical user interface that it is now their required timeframe for completing the condition report with the specified validator. The validator is also updated via the graphical user interface with the references condition report template and other data related to the commodity so they can perform the assessment in accordance with the terms of the process.

The final step of the process at the end of the algorithm is determined by whether the conditions of the sale have been met as determined by the validator. If the sale is final the escrow transaction is finalized and facilitated by the referenced technology and the commodity is transferred to the buyer. If the conditions are not met, the alternative scenarios include but are not limited to the refund of the buyer. At this point the transaction is complete; all parties in good standing have been satisfied.

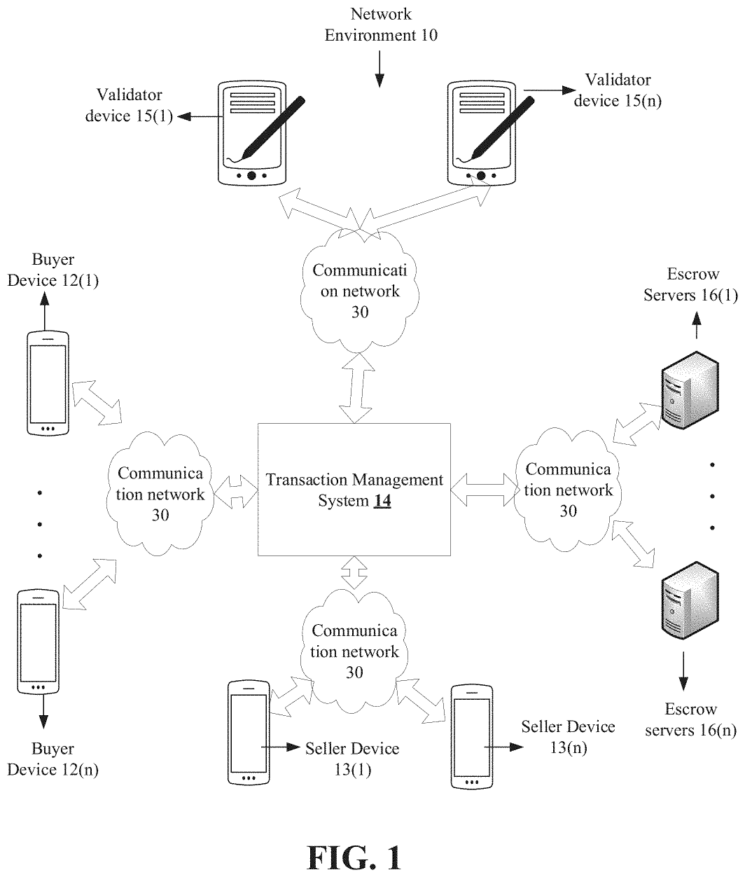

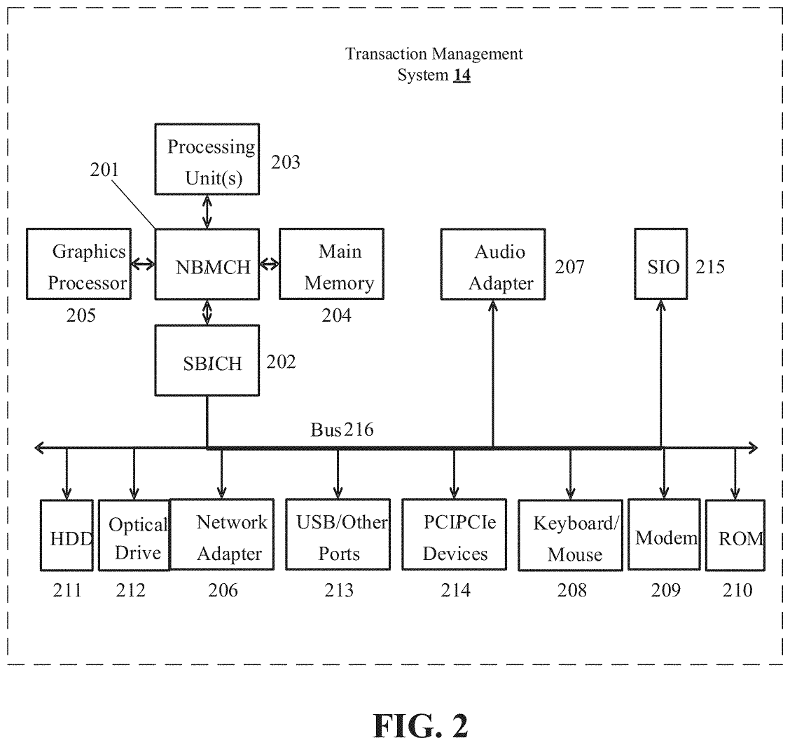

A network environment 10 with an example of a transaction management system 14 is illustrated in FIGS. 1-2. In this particular example, the environment 10 includes one or more buyer devices 12(1)-12(n), one or more seller devices 13(1)-13(n), the transaction management system 14, one or more validator devices 15(1)-15(n), and one or more escrow servers 16(1)-16(n), coupled via one or more communication networks 30, although the environment could include other types and numbers of systems, devices, components, and/or other elements as is generally known in the art and will not be illustrated or described herein. This technology provides a number of advantages including providing methods, non-transitory computer readable medium, and systems that provides managing of electronic transactions.

Referring more specifically to FIGS. 1-2, the transaction management system 14 is programmed to manage electronic transactions. Some examples of the transaction management system 14 can include a mobile device, a laptop, or an application executing on a mobile device. Now referring to FIG. 2, the transaction management system 14 can employ a hub architecture including a north bridge and memory controller hub (NB/MCH) 201 and south bridge and input/output (I/O) controller hub (SB/ICH) 202. Processing unit 203, main memory 204, and graphics processor 205 can be connected to the NB/MCH 201. Graphics processor 205 can be connected to the NB/MCH 201 through an accelerated graphics port (AGP).

In the depicted example, the network adapter 206 connects to the SB/ICH 202. The audio adapter 207, keyboard and mouse adapter 208, modem 209, read-only memory (ROM) 210, hard disk drive (HDD) 211, optical drive (CD or DVD) 212, universal serial bus (USB) ports and other communication ports 213, and the PCI/PCIe devices 214 can connect to the SB/ICH 202 through bus system 216. PCI/PCIe devices 214 may include Ethernet adapters, add-in cards, and PC cards for notebook computers. ROM 210 may be, for example, a flash basic input/output system (BIOS). The HDD 211 and optical drive 212 can use an integrated drive electronics (IDE) or serial advanced technology attachment (SATA) interface. The super I/O (SIO) device 215 can be connected to the SB/ICH 202.

An operating system can run on processing unit 203. The operating system can coordinate and provide control of various components within the transaction management system 14. As a client, the operating system can be a commercially available operating system. An object-oriented programming system, such as the Java™ programming system, may run in conjunction with the operating system and provide calls to the operating system from the object-oriented programs or applications executing on the transaction management system 14. As a server, the transaction management system 14 can be an IBM® eServer™ System P® running the Advanced Interactive Executive operating system or the Linux operating system. The transaction management system 14 can be a symmetric multiprocessor (SMP) system that can include a plurality of processors in the processing unit 203. Alternatively, a single processor system may be employed.

Instructions for the operating system, the object-oriented programming system, and applications or programs are located on storage devices, such as the HDD 211, and are loaded into the main memory 204 for execution by the processing unit 203. The processes for embodiments of the full question generation system can be performed by the processing unit 203 using computer usable program code, which can be located in a memory such as, for example, main memory 204, ROM 210, or in one or more peripheral devices.

A bus system 216 can be comprised of one or more busses. The bus system 216 can be implemented using any type of communication fabric or architecture that can provide for a transfer of data between different components or devices attached to the fabric or architecture. A communication unit such as the modem 209 or network adapter 206 can include one or more devices that can be used to transmit and receive data.

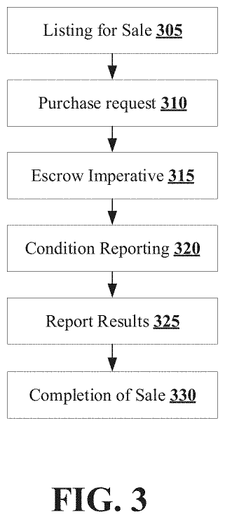

Those of ordinary skill in the art will appreciate that the hardware depicted in FIG. 2 may vary depending on the implementation. For example, the transaction management system 14 includes several components that would not be directly included in some embodiments illustrated in FIGS. 3-6. However, it should be understood that the embodiments illustrated in FIGS. 3-6 may include one or more of the components and configurations of the transaction management system 14 for performing processing methods and steps in accordance with the disclosed embodiments.

Moreover, other internal hardware or peripheral devices, such as flash memory, equivalent non-volatile memory, or optical disk drives may be used in addition to or in place of the hardware depicted. Moreover, the transaction management system 14 can take the form of any of a number of different data processing systems, including but not limited to, client computing devices, server computing devices, tablet computers, laptop computers, telephone or other communication devices, personal digital assistants, and the like. Essentially, transaction management system 14 can be any known or later developed data processing system without architectural limitation.

Referring back to FIG. 1, each of the one or more buyer devices 12(1)-12(n) may request the transaction management system 14 for initiating and purchase of a commodity via one or more of the communication networks 30, for example, although other types and/or numbers of storage media in other configurations could be used. In this particular example, each of the one or more buyer devices 12(1)-12(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, HTTPS, and/or FTP applications, may be operating on the one or more buyer devices 12(1)-12(n) and may transmit data in response to requests from the transaction management system 14. Each of the one or more buyer devices 12(1)-12(n) may include a processor, a memory, and a communication interface, which are coupled together by a bus or other link, although each may have other types and/or numbers of other systems, devices, components, and/or other elements.

Each of the one or more seller devices 13(1)-13(n) may request the transaction management system 14 for initiating and selling of a commodity via one or more of the communication networks 30, for example, although other types and/or numbers of storage media in other configurations could be used. In this particular example, each of the one or more seller devices 13(1)-13(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, HTTPS, and/or FTP applications, may be operating on the one or more seller devices 13(1)-13(n) and may transmit data in response to requests from the transaction management system 14. Each of the one or more seller devices 13(1)-13(n) may include a processor, a memory, and a communication interface, which are coupled together by a bus or other link, although each may have other types and/or numbers of other systems, devices, components, and/or other elements.

Each of the one or more validator devices 15(1)-15(n) assists with providing condition validation reports associated with the commodity, although the one or more validator devices 15(1)-15(n) can assist with other types or amounts of different operations. In this particular example, each of the one or more validator devices 15(1)-15(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, HTTPS, and/or FTP applications, may be operating on the one or more validator devices 15(1)-15(n) and may transmit data in response to requests from the transaction management system 14. Each of the one or more validator devices 15(1)-15(n) may include a processor, a memory, and a communication interface, which are coupled together by a bus or other link, although each may have other types and/or numbers of other systems, devices, components, and/or other elements.

Next, each of the one or more escrow servers 16(1)-16(n) may assist the transaction management system 14 as an escrow account via one or more of the communication networks 30, for example, although other types and/or numbers of storage media in other configurations could be used. In this particular example, each of the one or more escrow servers 16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the one or more escrow servers 16(1)-16(n) and may transmit data in response to requests from the transaction management system 14. Each of the one or more escrow servers 16(1)-16(n) may include a processor, a memory, and a communication interface, which are coupled together by a bus or other link, although each may have other types and/or numbers of other systems, devices, components, and/or other elements.

The non-transitory computer readable storage medium can be a tangible device that can retain and store instructions for use by an instruction execution device. The non-transitory computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), solid state drives (SSD) a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A non-transitory computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The non-transitory computer readable program instructions described herein can be downloaded to respective computing/processing devices from a computer readable storage medium or to an external computer or external storage device via a communication network 30, for example, the Internet, a local area network (LAN), a wide area network (WAN) and/or a wireless network. The communication network 30 may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java™, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of communication network 30, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Although the transaction management system 14 illustrated as a single device, the functions or operations distributed across one or more distinct network computing devices. Moreover, the transaction management system 14 is not limited to a particular configuration. Thus, the transaction management system 14 may operate as a plurality of network computing devices within cluster architecture, a peer-to peer architecture, virtual machines, or within a cloud architecture.

While transaction management system 14 is illustrated in this example as including a single device, the transaction management system 14 in other examples can include a plurality of devices or blades each with one or more processors each processor with one or more processing cores that implement one or more steps of this technology. In these examples, one or more of the devices can have a dedicated communication interface or memory.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present description and claims may make use of the terms “a,” “at least one of,” and “one or more of,” with regard to particular features and elements of the illustrative embodiments. It should be appreciated that these terms and phrases are intended to state that there is at least one of the particular features or elements present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the Figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112 (f), unless the element is expressly recited using the phrase “means for.”

An exemplary method for managing electronic transactions will now be illustrated with reference to FIGS. 3-6. In step 305, the transaction management system 14 receives a listing for sale from one of the seller devices 13(1)-13(n). In this example, seller using the one of the seller devices 13(1)-13(n) shall list a commodity for sale on an online marketplace hosted by the transaction management system 14 via a graphical user interface that is provided by the transaction management system 14. Next, the transaction management system 14 receives a list of conditions that the commodity will be evaluated against later during the sales process from the seller devices 13(1)-13(n). Additionally, in this example, a seller via the seller devices 13(1)-13(n) shall select a condition reporter using one or more of the validator devices 15(1)-15(n) from a network of accepted condition reporters or supply their own vendor for performing the condition report that will include the disclosed attributes in the point above. Furthermore, the seller via the seller devices 13(1)-13(n) shall agree to the fee structure for this commodity listing, which may come in the form of a classified listing (fixed ask price) or an auction (final price relative to highest bid but no lower than the predefined reserve price).

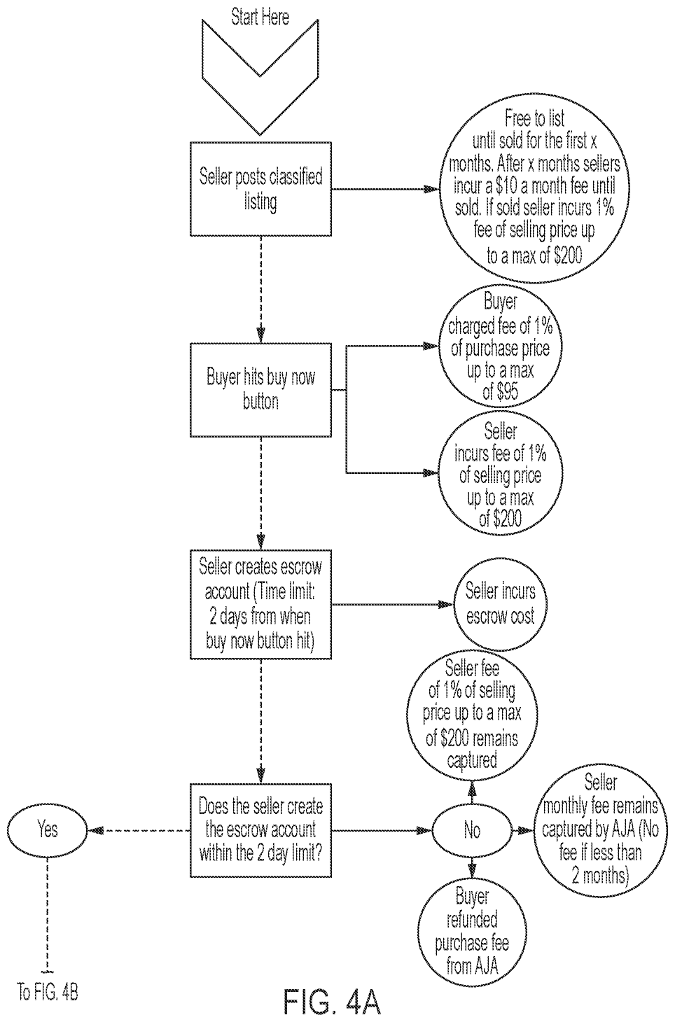

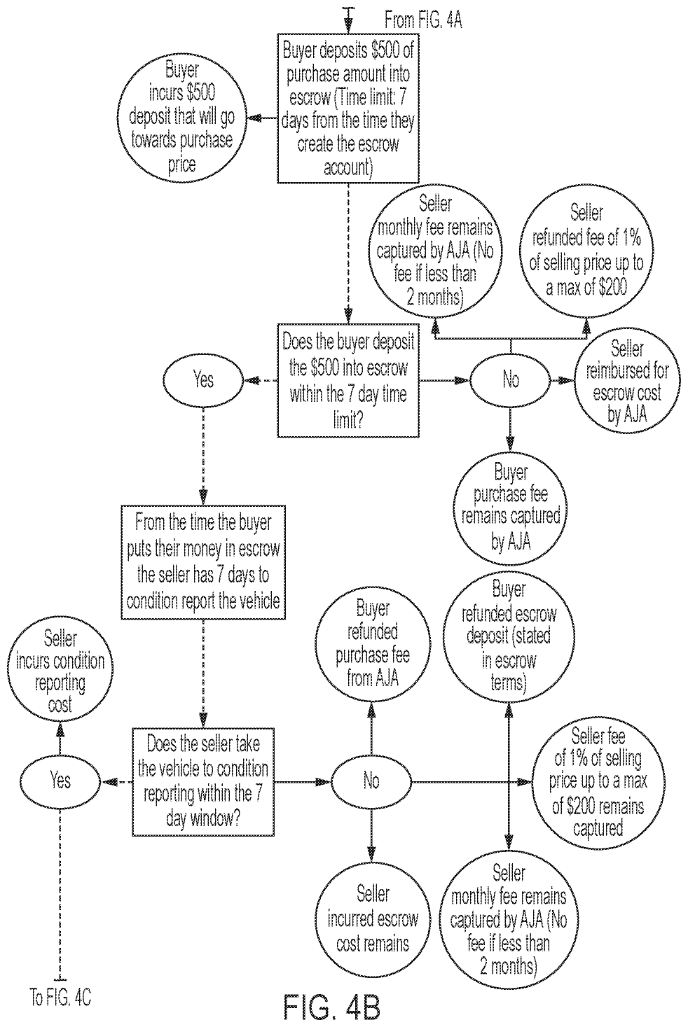

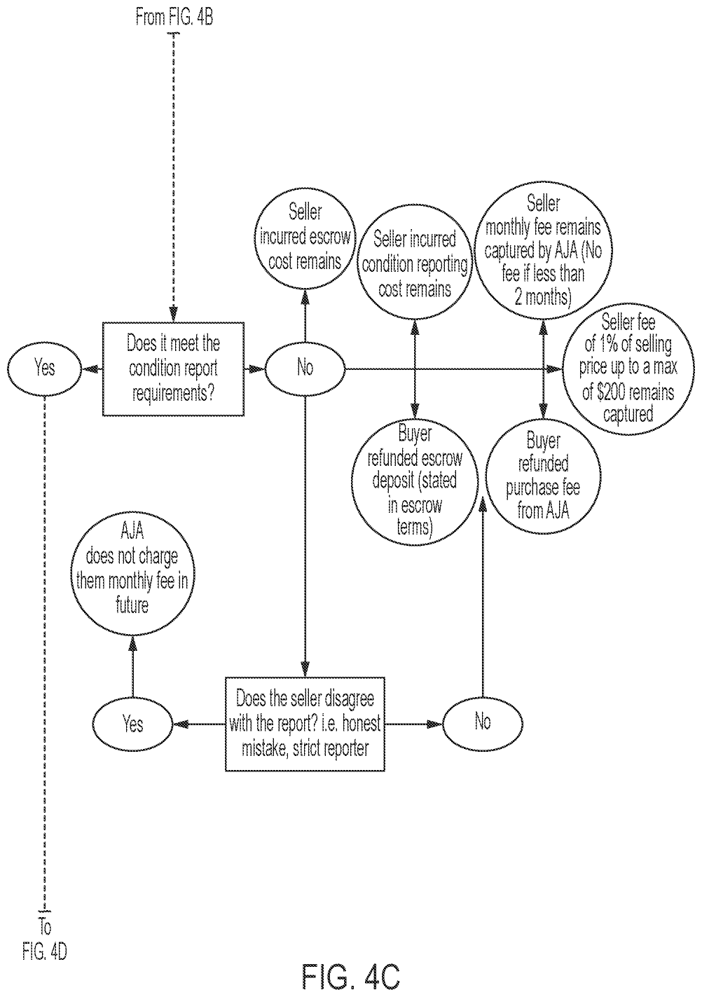

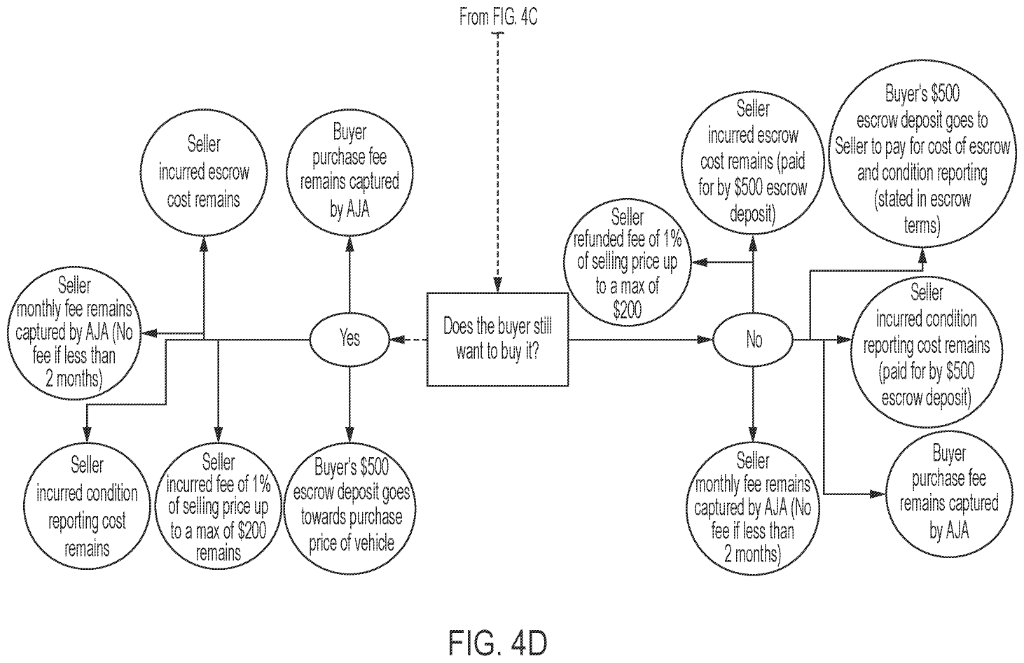

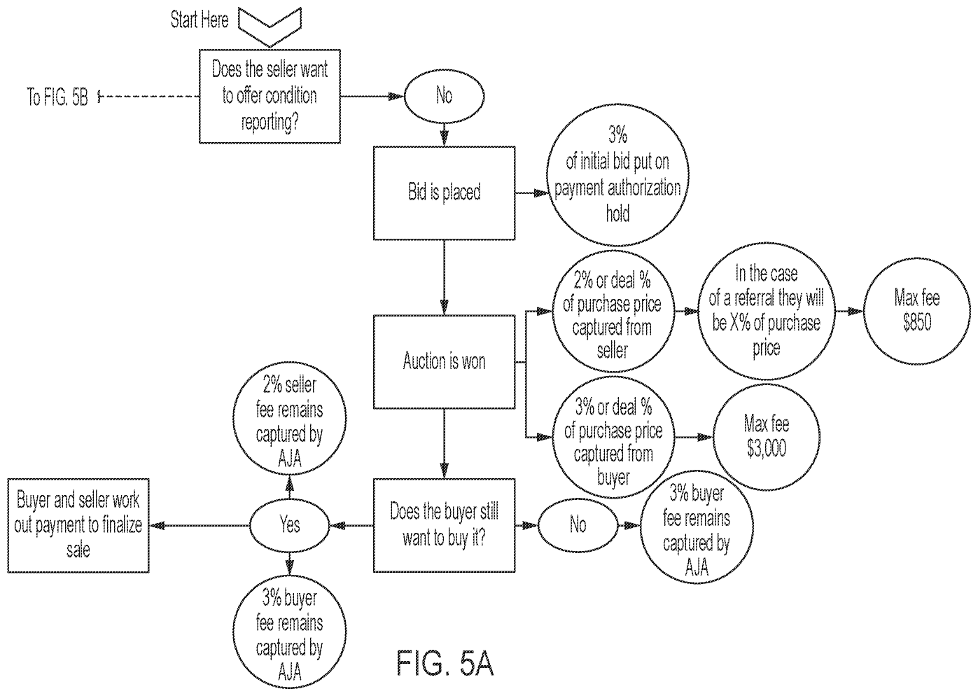

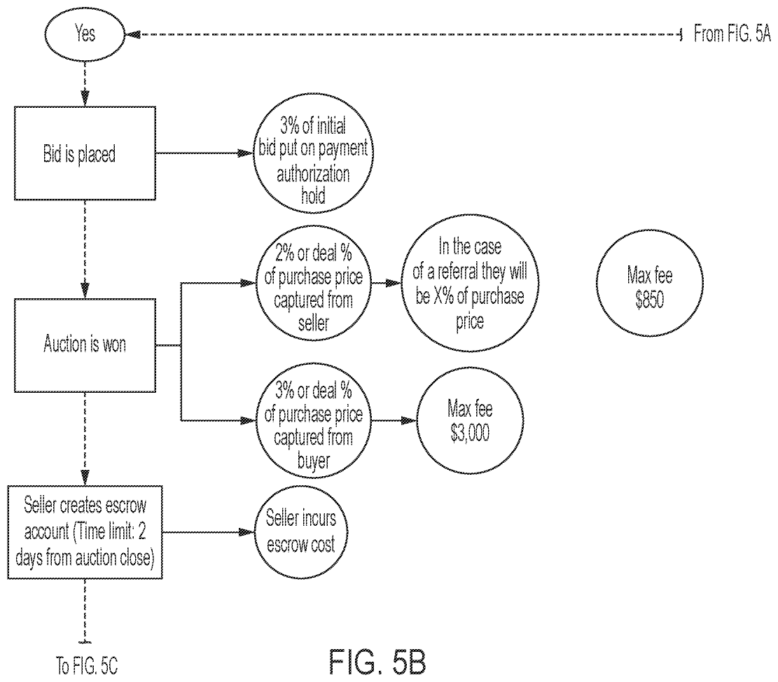

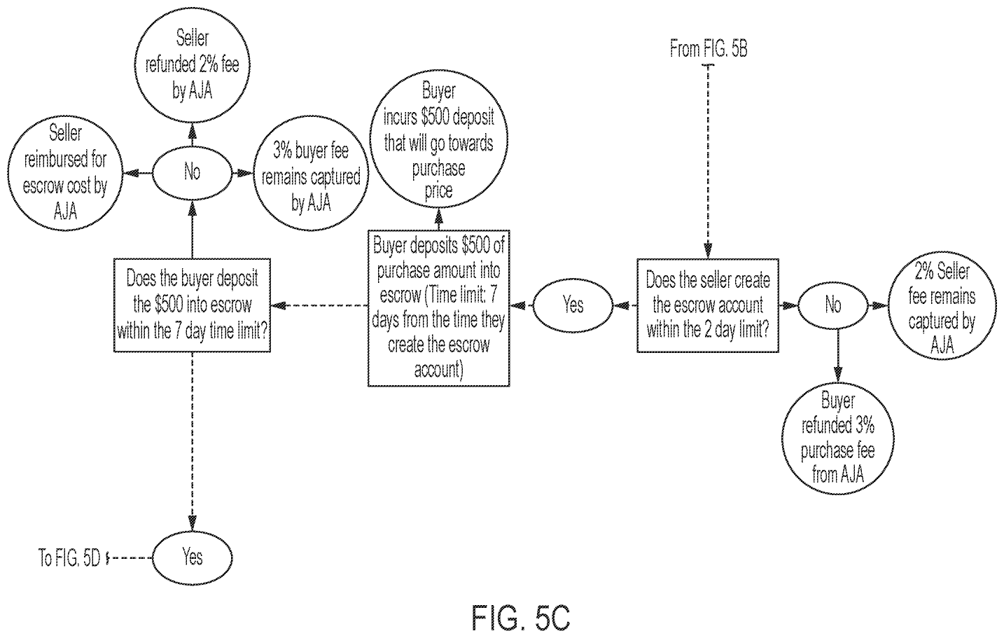

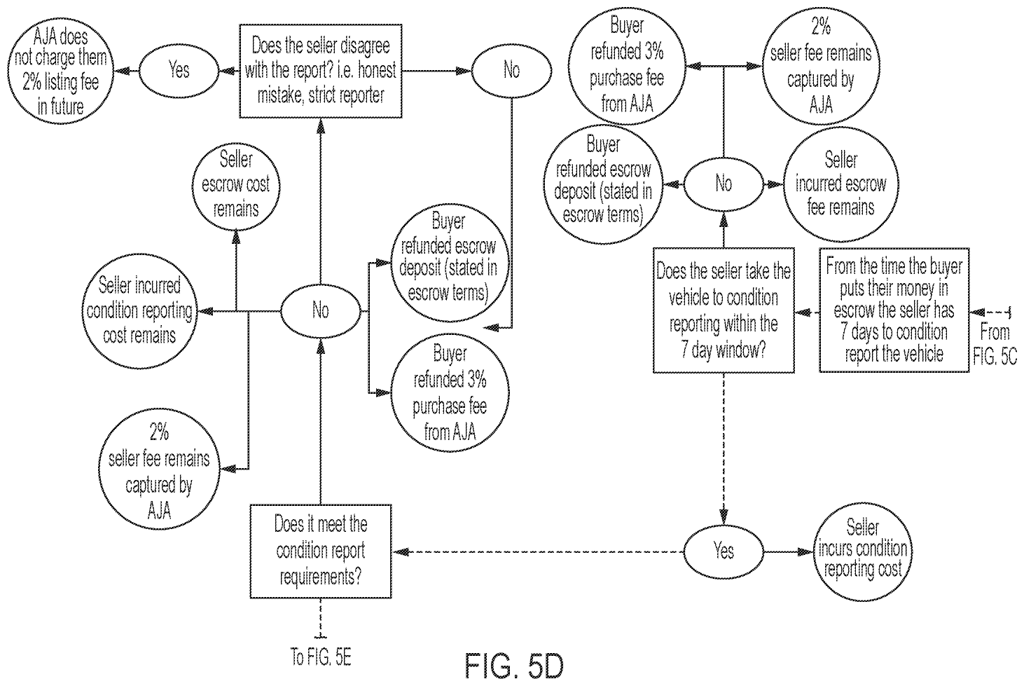

Next in step 310, the transaction management system 14 receives a purchase request from one of the one or more buyer devices 12(1)-12(n) via a graphical user interface that is generated by the transaction management system 14. Flowcharts illustrated in FIGS. 4A-5E provide a detailed illustration of the step of receiving the purchase request. In this example, before a purchase request is made, a buyer via the one or more buyer devices 12(1)-12(n) has the opportunity to request additional conditions to be included in the report and an additional condition reporter be considered for performing the report. Furthermore, the seller via one or more seller devices 13(1)-13(n) can accept or reject these additions and all conditions and reporters are public and pre-disclosed. Additionally, in this example, buyer via the buyer devices 12(1)-12(n) shall demonstrate intent to purchase by placing a winning bid or choosing ‘buy now’. Furthermore, in this example, the buyer via the buyer devices 13(1)-13(n) shall complete initial purchase process that includes agreeing to the terms and condition of this business process, paying applicable service fee for our platform and consenting to enter into the contract with the seller that requires the remaining steps in the process be completed. Also, the seller via the seller devices 13(1)-13(n) shall pay applicable platform fees for marketing etc.

Next in step 315, the transaction management system 14 assists with the escrow account. Flowcharts illustrated in FIGS. 4A-5E provide a detailed illustration of the step of assisting with the escrow account. In this example, once an available commodity has had intent to purchase solidified it moves to a state we refer to as ‘under contract’ and the buyer and seller are now obligated to continue the sale by utilizing an escrow account. Additionally, in this example, the buyer is obligated to deposit the pre-determined amount into the escrow account equal to the amount that the condition reporter will charge. Furthermore, in this example, buyer is obligated to deposit these funds within a time window or else the arrangement will be void and the commodity will be available for other purchasers and buyers failing to comply will result in the seller being made whole.

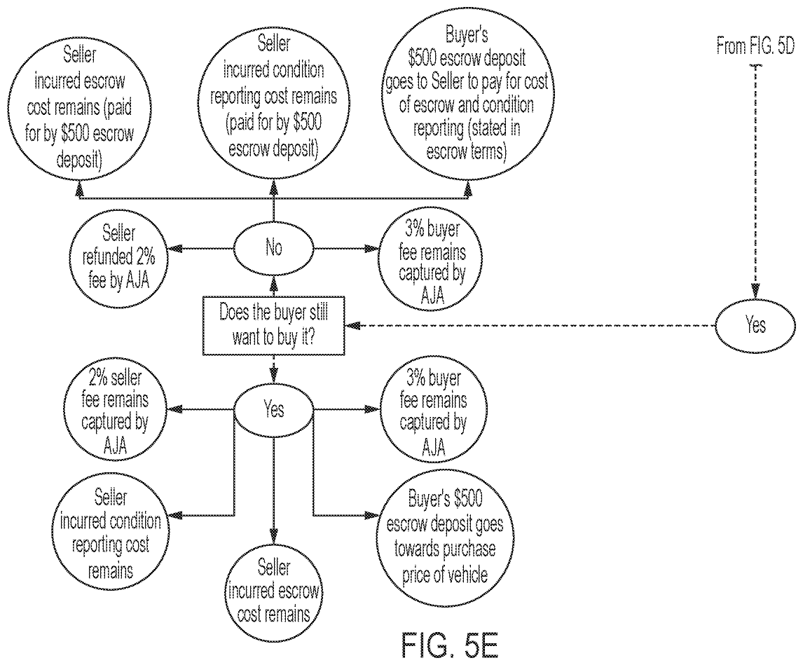

In step 320, the transaction management system 14 assists with condition reporting. Flowcharts illustrated in FIGS. 4A-5E provide a detailed illustration of the step of condition reporting. In this step, when the buyer via the buyer devices 12(1)-12(n) has deposited the necessary funds into the escrow account, the seller via the seller devices 13(1)-13(n) is then obligated to have a condition report performed by the agreed upon vendor in accordance with the disclosed list of conditions and attributes originated by the seller and any additional conditions that the buyer requested be added to the list before intent to purchase was solidified, and that the seller agrees to. An example of the condition report is illustrated in FIG. 6. By way of example, the condition report illustrated in FIG. 6 includes a condition report of a vehicle that includes the description of the vehicle and the condition of the vehicle. Additionally, seller via the seller devices 13(1)-13(n) is obligated to complete this within a time window and if the seller via the seller devices 13(1)-13(n) does not complete this step within a time window the funds in escrow will be released to the buyer and the buyer in this case shall be made whole.

In this example, the transaction management system 14 receives the data associated with the condition of the commodity (such as a car) in the form of images, receipts of any repair that is performed, parts that are replaced, accident reports via the graphical user interface, although the transaction management system 14 can receive other types of images. Further, in this example, the transaction management system 14 can process the received images to remove the noise and/or other objects of non-interest from the received images. Next, the transaction management system 14 can correlate the data that is received against the information that is present within the condition report to determine if there is a correlation. For example, the transaction management system 14 can identify the image associated with right front bumper of a car and associate the corresponding description in the condition report to determine if the condition is accurate. Alternative, the transaction management system 14 can use the data that is received from one of the one or more of the validator devices 15(1)-15(n) to assist with preparation of the condition report by automatically filling a portion or the entire condition report. For example, the transaction management system 14 can analyze the image of a car and identify a dent on the front bumper and can then automatically enter the information regarding the identified dent on the front bumper in the condition report. By way of example, the transaction management system 14 can scan the received image and identify a dent in the front bumper of a car. Further, the transaction management system 14 can describe the dent in the front bumper of a car within the condition report. Optionally, the transaction management system 14 can also use artificial intelligence models to assist with analyzing the received data and completing the condition report.

In step 325, the transaction management system 14 assists with reporting the results. In this example, if the condition report has a suitable result the buyer shall be obligated to complete the purchase in the amount of the difference between the initial deposit into escrow and the final purchase price determined at intent to purchase. However, if the condition report does not have a suitable result the buyer shall be made whole. Furthermore, in this example, if a seller believes a negative judgement was incorrect, then the transaction management system 14 assists with resolving the dispute and the buyer shall be made whole and the contract void. Additionally, in this example, if the seller refuses to complete the transaction, then the buyer shall be made whole.

In step 330, the transaction management system 14 assists with completion of sale. Flowcharts illustrated in FIGS. 4A-5E provide a detailed illustration of the step of completing the sale of the commodity. In this example, buyer via the buyer devices 12(1)-12(n) shall utilize the escrow account hosted by the escrow servers 16(1)-16(n) established to complete the sale in accordance with the remaining balance. Additionally, in this example, if the Buyer is determined not to finalize the purchase despite a positive judgement in the condition report, then the seller shall be made whole. In this example, the transaction management system 14 renders their service fees back to them and their expenses for condition reporting and escrow shall be rendered to them from the buyers escrow deposit hosted by the escrow servers 16(1)-16(n).

Although the disclosed technology has been described with reference to exemplary embodiments, it is not limited thereto. Those skilled in the art will appreciate that numerous changes and modifications may be made to the preferred embodiments of the invention and that such changes and modifications may be made without departing from the true spirit of the disclosed technology. It is therefore intended that the appended claims be construed to cover all such equivalent variations as they fall within the true spirit and scope of the disclosed technology.

What is claimed is:

1. A method for managing electronic transactions, the method comprising:
receiving, by a transaction management system, a commodity to be listed for sale via a graphical user interface;
receiving, by the transaction management system, a purchase request for the commodity listed for sale via the graphical user interface;
determining, by the transaction management system, when to pre-disclose condition data, which will be subsequently utilized in a condition report, and facilitating the condition report for the commodity listed for sale, wherein the pre-disclosed condition data may be automatically generated based on one or more images associated with the commodity and the commodity description data;
determining, by the transaction management system, what third party business will be identified as the condition reporter tasked with facilitating the condition report that references the pre-disclosed condition data to determine if the commodity meets its obligations and expectations, wherein the condition reporter is selected by the seller may come from a vetted and validated network of condition reporters that is maintained and provided as a convenience to our customers; and
completing, by the transaction management system, sale of the commodity, utilizing an escrow server, based on the result of a condition report containing determined pre-disclosure data and the condition report data.

2. The method as set forth in claim 1 further comprising, receiving, by the transaction management system, a buyer instruction and a seller instruction to an escrow account hosted via an escrow server to complete the sale of the commodity, wherein the buyer will be released from their obligation to purchase the commodity if the seller does not set up the escrow server in the determine timeframe and wherein the seller will be released from their obligations if the buyer does not deposit the required initial deposit into the escrow account within the determine timeframe in the event that the escrow account is established within the timeframe.

3. The method as set forth in claim 1 further comprising:
receiving, by the transaction management system, pre-disclosed condition data associated with the commodity to be evaluated during a condition report; and
assigning, by the transaction management system, an attribute to be associated with each condition disclosed, wherein the attribute may be a descriptor comprising exact, exact with minor variance, or condition validator judgement, and shall set the expectation for the condition validator when making a judgement on the precision of the conditions disclosed.

4. The method as set forth in claim 3 further comprising, providing, by the transaction management system, the pre-disclosed condition data originated by the seller being made available to the buyer before any purchase request is made, wherein the buyer may request for the seller to include additional conditions that, if accepted, will be pre-disclosed with the other condition data before purchase request is received, wherein the seller is required to pre-disclose the condition reporter who will be tasked with the condition report, and wherein the condition reporters are listed where the potential buyer can request an additional condition reporter for the seller to consider that, if accepted, would be pre-disclosed before a purchase request came in.

5. The method as set forth in claim 1 further comprising, processing, by the transaction management system, a listing fee and a purchase fee for the commodity.

6. The method as set forth in claim 1 further comprising:
releasing, by the transaction management system, the escrow account when the condition report data is not provided within a determined time period making the buyer whole, wherein the condition report is completed and the condition report results do match the pre-disclosed conditions, the buyer is obligated to complete the remaining transaction utilizing the escrow service, and if they do not, the seller is made whole utilizing the initial deposit from the buyer, and wherein the condition report is completed but the condition report results do not match the pre-disclosed conditions, the buyer shall be released from their obligation to purchase the commodity and is entitled to be made whole from the funds deposited into escrow and the buyer retains the right to continue with the transaction despite the unfavorable report result at their own discretion; and
aggregating, by the transaction management system, a detailed historical record of subsequent condition reports and publicly available artifacts relating to the commodity listed for sale, wherein the commodities listed for sale are identified uniquely by some value and have their public records and condition reports associated with that value, the condition reports and artifacts are then accessed and referenced in the event that a commodity is re-listed for sale in a separate transaction.

7. A non-transitory machine readable medium having stored thereon instructions comprising machine executable code which when executed by at least one machine causes the machine to:
receive a commodity to be listed for sale via a graphical user interface;
receive a purchase request for the commodity listed for sale via the graphical user interface;
determine when to pre-disclose condition data, which will be subsequently utilized in a condition report, and facilitating the condition report for the commodity listed for sale, wherein the pre-disclosed condition data may be automatically generated based on one or more images associated with the commodity and the commodity description data;
determine what third party business will be identified as the condition reporter tasked with facilitating the condition report that references the pre-disclosed condition data to determine if the commodity meets its obligations and expectations, wherein the condition reporter is selected by the seller may come from a vetted and validated network of condition reporters that is maintained and provided as a convenience to our customers; and
complete sale of the commodity, utilizing an escrow server, based on the result of a condition report containing determined pre-disclosure data and the condition report data.

8. The medium as set forth in claim 7 further comprising, receiving a buyer instruction and a seller instruction to an escrow account hosted via an escrow server to complete the sale of the commodity, wherein the buyer will be released from their obligation to purchase the commodity if the seller does not set up the escrow server in the determine timeframe and wherein the seller will be released from their obligations if the buyer does not deposit the required initial deposit into the escrow account within the determine timeframe in the event that the escrow account is established within the timeframe.

9. The medium as set forth in claim 7 further comprising:
receiving pre-disclosed condition data associated with the commodity to be evaluated during a condition report; and
assigning an attribute to be associated with each condition disclosed, wherein the attribute may be a descriptor comprising exact, exact with minor variance, or condition validator judgement, and shall set the expectation for the condition validator when making a judgement on the precision of the conditions disclosed.

10. The medium as set forth in claim 9 further comprising, providing the pre-disclosed condition data originated by the seller being made available to the buyer before any purchase request is made, wherein the buyer may request for the seller to include additional conditions that, if accepted, will be pre-disclosed with the other condition data before purchase request is received, wherein the seller is required to pre-disclose the condition reporter who will be tasked with the condition report, and wherein the condition reporters are listed where the potential buyer can request an additional condition reporter for the seller to consider that, if accepted, would be pre-disclosed before a purchase request came in.

11. The medium as set forth in claim 7 further comprising, processing a listing fee and a purchase fee for the commodity.

12. The medium as set forth in claim 7 further comprising:
releasing the escrow account when the condition report data is not provided within a determined time period making the buyer whole, wherein the condition report is completed and the condition report results do match the pre-disclosed conditions, the buyer is obligated to complete the remaining transaction utilizing the escrow service, and if they do not, the seller is made whole utilizing the initial deposit from the buyer, and wherein the condition report is completed but the condition report results do not match the pre-disclosed conditions, the buyer shall be released from their obligation to purchase the commodity and is entitled to be made whole from the funds deposited into escrow and the buyer retains the right to continue with the transaction despite the unfavorable report result at their own discretion; and
aggregating a detailed historical record of subsequent condition reports and publicly available artifacts relating to the commodity listed for sale, wherein the commodities listed for sale are identified uniquely by some value and have their public records and condition reports associated with that value, the condition reports and artifacts are then accessed and referenced in the event that a commodity is re-listed for sale in a separate transaction.

13. A transaction management system, comprising a memory comprising programmed instructions stored in the memory and one or more processors configured to be capable of executing the programmed instructions stored in the memory to:
receive a commodity to be listed for sale via a graphical user interface;
receive a purchase request for the commodity listed for sale via the graphical user interface;
determine when to pre-disclose condition data, which will be subsequently utilized in a condition report, and facilitating the condition report for the commodity listed for sale, wherein the pre-disclosed condition data may be automatically generated based on one or more images associated with the commodity and the commodity description data or entered manually;
determine what third party business will be identified as the condition reporter tasked with facilitating the condition report that references the pre-disclosed condition data to determine if the commodity meets its obligations and expectations, wherein the condition reporter is selected by the seller may come from a vetted and validated network of condition reporters that is maintained and provided as a convenience to our customers; and
complete sale of the commodity, utilizing an escrow server, based on the result of a condition report containing determined pre-disclosure data and the condition report data.

14. The system as set forth in claim 13 wherein the one or more processors are further configured to be capable of executing the programmed instructions stored in the memory to receive a buyer instruction and a seller instruction to an escrow account hosted via an escrow server to complete the sale of the commodity, wherein the buyer will be released from their obligation to purchase the commodity if the seller does not set up the escrow server in the determine timeframe and wherein the seller will be released from their obligations if the buyer does not deposit the required initial deposit into the escrow account within the determine timeframe in the event that the escrow account is established within the timeframe.

15. The system as set forth in claim 13 wherein the one or more processors are further configured to be capable of executing the programmed instructions stored in the memory to:
receive pre-disclosed condition data associated with the commodity to be evaluated during a condition report; and
assign an attribute to be associated with each condition disclosed, wherein the attribute may be a descriptor comprising exact, exact with minor variance, or condition validator judgement, and shall set the expectation for the condition validator when making a judgement on the precision of the conditions disclosed.

16. The system as set forth in claim 15 wherein the one or more processors are further configured to be capable of executing the programmed instructions stored in the memory to provide the pre-disclosed condition data originated by the seller being made available to the buyer before any purchase request is made, wherein the buyer may request for the seller to include additional conditions that, if accepted, will be pre-disclosed with the other condition data before purchase request is received, wherein the seller is required to pre-disclose the condition reporter who will be tasked with the condition report, and wherein the condition reporters are listed where the potential buyer can request an additional condition reporter for the seller to consider that, if accepted, would be pre-disclosed before a purchase request came in.

17. The system as set forth in claim 13 wherein the one or more processors are further configured to be capable of executing the programmed instructions stored in the memory to process a listing fee and a purchase fee for the commodity.

18. The system as set forth in claim 13 wherein the one or more processors are further configured to be capable of executing the programmed instructions stored in the memory to:
release the escrow account when the condition report data is not provided within a determined time period making the buyer whole, wherein the condition report is completed and the condition report results do match the pre-disclosed conditions, the buyer is obligated to complete the remaining transaction utilizing the escrow service, and if they do not, the seller is made whole utilizing the initial deposit from the buyer, and wherein the condition report is completed but the condition report results do not match the pre-disclosed conditions, the buyer shall be released from their obligation to purchase the commodity and is entitled to be made whole from the funds deposited into escrow and the buyer retains the right to continue with the transaction despite the unfavorable report result at their own discretion; and
aggregate a detailed historical record of subsequent condition reports and publicly available artifacts relating to the commodity listed for sale, wherein the commodities listed for sale are identified uniquely by some value and have their public records and condition reports associated with that value, the condition reports and artifacts are then accessed and referenced in the event that a commodity is re-listed for sale in a separate transaction.
